(19) United States
(12) Patent Application Publication
(10) Pub. No.: US 2022/0065532 A1
(43) Pub. Date: Mar. 3, 2022

(54) METALLURGICAL FURNACE

(71) Applicant: REFRACTORY INTELLECTUAL PROPERTY GMBH & CO. KG, Wien (AT)

(72) Inventor: Bojan Zivanovic, Wien (AT)

(21) Appl. No.: 17/418,763

(22) PCT Filed: Dec. 4, 2019
(86) PCT No.: PCT/EP2019/083709

§ 371 Date: Jun. 25, 2021

(30) Foreign Application Priority Data
Mar. 11, 2019 (EP) 19161968.3

(51) Int. Cl. F27B 3/14; F27D 1/00; F27D 1/12; F27D 9/00; C22B 15/00; C22B 5/02

(52) U.S. Cl. CPC F27B 3/14; F27D 1/004; F27D 1/12; F27D 2009/0062; C22B 15/0028; C22B 5/02; F27D 9/00

(57) ABSTRACT

The invention relates to a metallurgic furnace, in particular a metallurgic furnace for receiving a molten metal.

### DESCRIPTION

The invention relates to a metallurgical furnace, in particular to a metallurgical furnace for receiving a molten metal.

Metallurgical furnaces for receiving a molten metal are known, for example, in the form of blast furnaces, electric furnaces or in the form of furnaces operating according to the flash smelting method.

Such metallurgical furnaces for receiving a molten metal comprise a furnace wall enclosing a furnace chamber. The furnace chamber is designed to receive the molten metal. In particular, the areas of the furnace wall which come into contact with the molten metal have a masonry of refractory bricks, the refractory bricks coming into contact with the molten metal.

Due to the high temperatures of the molten metal, the refractory bricks are subjected to high thermal stress, which causes the refractory bricks to undergo thermal wear. To reduce this thermal wear, it is known to cool the refractory bricks. In this respect, it is known to thermally connect the masonry formed from the refractory bricks to a metal element on the side of the masonry facing away from the molten metal, i.e. on the cold side of the refractory bricks. The heat transferred from the molten metal to the refractory bricks can thereby be dissipated from the refractory bricks by the metal element thermally connected to the refractory bricks.

For example, such a metal element is known in the form of a copper plate, which may, for example, also have channels for passing a cooling fluid, so that the heat transferred to the copper plate can be transferred to the cooling fluid and dissipated from the copper plate via the latter.

In addition to reducing the thermal stress on the refractory bricks of the masonry by such cooling, the cooling of the refractory bricks also has the advantage that caking, for example of solidified slag, can form on the hot side of the refractory bricks, i.e., on the side of the refractory bricks facing the molten metal, which can protect the refractory bricks from mechanical and corrosive stress by the molten metal and the slag.

A metallurgical furnace comprising such a cooling element in the form of a water-cooled copper plate is disclosed, for example, in EP 1 337 800 B1.

In order to avoid loosening of the refractory bricks from the brickwork during operation of the metallurgical furnace, it is known to fix the refractory bricks in the masonry by holding means.

EP 1 337 800 B1 discloses in this respect to fix the refractory bricks in horizontally running grooves which run in the cooling element.

Due to the temperature changes occurring in the refractory bricks during heating and cooling of the metallurgical furnace and, to a lesser extent, during operation of the metallurgical furnace, the refractory bricks of the masonry are subject to thermal expansion. However, this thermal expansion of the refractory bricks and the masonry formed from them must be taken into account during the construction of the masonry. In this respect, it is known to fix the refractory bricks of the masonry during its construction via the holding means in such a way that expansion joints remain between the refractory bricks. When the metallurgical furnace is heated up and the refractory bricks expand thermally as a result, these joints are gradually closed so that the refractory bricks form a jointless masonry structure when the operating temperature of the metallurgical furnace is reached.

In principle, metallurgical furnaces with such a furnace wall have indeed proved successful in practice. However, particularly during heating of the furnace, molten metal may flow into and through the masonry through the joints of the masonry that have not yet been closed. However, this can damage the furnace wall and in particular the cooling element of the furnace wall.

It is an object of the present invention to provide a metallurgical furnace, in particular a metallurgical furnace for receiving a molten metal, in which the refractory bricks forming the masonry of the furnace wall are held in the masonry, but at the same time, even in the event of thermal expansion of the refractory bricks, a jointless masonry can always be formed from these refractory bricks.

To solve this problem, according to the invention, there is provided a metallurgical furnace comprising the following features:

a furnace wall enclosing a furnace chamber;

the furnace wall comprises at least one cooling element, the cooling element comprising the following features:

a metal element comprising a side facing the furnace chamber;

a masonry arranged opposite the side of the metal element facing the furnace chamber and at a distance from said side of the metal element;

the masonry comprises refractory bricks arranged in several layers one above the other;

metal rails extending through the masonry;

guide means by which of which the metal rails are vertically guidable fastened to the metal element.

Accordingly, the metallurgical furnace according to the invention comprises, as known from the prior art, a furnace wall which encloses a furnace chamber, the furnace wall comprising a cooling element which comprises a metal element and a masonry arranged at a distance therefrom. However, the metallurgical furnace according to the invention is now distinguished from the metallurgical furnaces known in the prior art in that the metallurgical furnace according to the invention comprises metal rails extending through the masonry, the metal rails being vertically guidable fastened to the metal element via guide means.

Via the metal rails extending through the masonry, which are fastened to the metal element via the guide means, the refractory bricks forming the masonry are fixed in the masonry, i.e. fastened in the masonry, so that loosening or even falling out of the refractory bricks from the masonry can be prevented. It is particularly advantageous that the refractory bricks in the furnace wall of the furnace according to the invention are fixed in the masonry solely by means of the metal rails, i.e. no further fixing means are required to hold the refractory bricks in the masonry.

However, as the metal rails are at the same time vertically guidable fastened to the metal element via the guiding means, a vertical movability of the metal rails and thus also of the refractory bricks of the masonry is possible at the same time. In case of a thermal expansion of the refractory bricks resulting from a temperature change of the refractory bricks, these can always form a jointless masonry and at the same time be held in the masonry by the metal rails.

In this respect, the vertically guidable guide means attached to the metal element can rather “follow” the thermal expansion of the refractory bricks in vertical direction.

As a result, a jointless masonry can always be formed even if the temperature of the refractory bricks changes, so that in the metallurgical furnace according to the invention, penetration of molten metal into and through the masonry can be prevented even if the temperature changes.

The masonry comprises refractory bricks arranged in several layers one above the other. Each layer preferably comprises a plurality of refractory bricks arranged side by side, that is, in a horizontal direction.

Preferably, the refractory bricks are essentially cuboid-shaped, with the refractory bricks preferably each having the same dimensions. This makes it possible in a particularly simple manner to form a masonry structure from the refractory bricks comprising a plurality of layers arranged one above the other.

According to the invention, it was found that due to a strong temperature gradient in the masonry, stresses can build up in it which can lead to stress cracks in the refractory bricks if the masonry has a depth (i.e. an extension from the side of the masonry facing the furnace chamber to the side facing the metal element) of more than 500 mm. It was also found that the masonry can insulate inadequately if it has a depth of less than 200 mm. In this respect, the refractory bricks or the masonry preferably have a depth in the range of 200 mm to 500 mm.

In principle, the refractory bricks can be made of any material known for refractory bricks in generic metallurgical furnaces. Preferably, the bricks are formed of a ceramic refractory material, particularly preferably a sintered ceramic refractory material. For example, the bricks may be in the form of magnesia-chromite bricks or in the form of alumina-chromite bricks.

According to a particularly preferred embodiment, the refractory bricks are slidable or movable along the metal rails. This has the particular advantage that the masonry, in particular also particularly well, as far as the masonry is in the form of a mortarless masonry, as set forth in the following, can react even more flexibly to thermal expansions of the refractory bricks.

Particularly preferably, the masonry is made of the refractory bricks without mortar, i.e. without mortar on the surfaces facing each other between adjacent refractory bricks. Particularly preferably, adjacent refractory bricks in the masonry lie jointless, i.e. with their surfaces facing each other directly against each other. In this respect, the masonry can be a mortarless dry masonry made of the refractory bricks.

A particular advantage of such a masonry constructed without mortar from the refractory bricks is that the masonry can react very flexibly to thermal expansion of the refractory bricks and the refractory bricks—in addition to their vertical movability through the vertically guided metal rails—also have further degrees of freedom with regard to their movability, in particular in the horizontal direction or along the metal rails.

The metal rails running through the masonry preferably run straight, i.e. along a linear longitudinal axis. This has the particular advantage that the refractory bricks of the masonry can be arranged along the metal rails in such a way that they can be moved or displaced particularly easily, so that they can move or expand along the metal rails in the event of thermal expansion.

Preferably, the metal rails run along the side of the metal element facing the furnace chamber, preferably at a constant distance from the metal element. This also has the particular advantage that the distance between the metal element and the masonry always remains the same even if the refractory bricks of the masonry move horizontally, whereby, in particular also insofar as a sealing means is arranged between the masonry and the metal element to improve thermal conductivity, good thermal contact can always be established between the masonry and the metal element.

Particularly preferably, the metal rails run horizontally. This has the particular advantage that the refractory bricks of the masonry are always securely held on the metal rails even during horizontal movement along the metal rails and, for example, sliding down of the refractory bricks can be prevented when they are displaced along the metal rails.

Preferably, the metal rails are made of a metal that is a good conductor of heat, such as steel or copper. Particularly preferably, the metal rails are made of steel; although steel has a lower thermal conductivity than copper, steel has been found to be more advantageous due to its higher strength compared to copper.

Preferably, the metal rails run parallel and spaced apart.

According to a particularly preferred embodiment, the metal rails run through the masonry in grooves formed in the refractory bricks of the masonry. In particular, this also has the advantage that the metal rails can be arranged particularly easily in the masonry. For example, this also has the advantage that a single refractory brick can be removed from the masonry without having to remove an entire layer of refractory bricks or even the entire masonry from the metal rails for this purpose.

Preferably, the grooves run through the masonry or through the refractory bricks at a distance from the two sides of the masonry facing the metal element or the furnace chamber. The grooves thus run “inside” the masonry through it. Accordingly, the metal rails running through these grooves also run “inside” through the masonry. On the one hand, this has the advantage that the refractory bricks are thus particularly secure against falling out of the masonry. On the other hand, however, this also has the advantage that heat can be transferred particularly well from the refractory bricks to the metal rails and can be dissipated from the refractory bricks to the outside or transferred to the metal element.

According to the invention, it was found that particularly good heat dissipation from the refractory bricks to the metal rails can be achieved if the metal rails run through the masonry in areas that are spaced at least 30 mm from the side of the masonry or the refractory bricks facing the metal element. Furthermore, it has been found that the statics of the masonry can be negatively affected if the metal rails run through the masonry in areas that are more than 50% of the depth of the masonry (again, viewed from the side of the masonry facing the metal element). Preferably, therefore, it may be provided that the metal rails pass through the masonry in areas spaced at least 30 mm from the side of the masonry or refractory bricks facing the metal element, and it may further be provided that the metal rails do not pass through the masonry in areas greater than 50% of the depth of the masonry. According to a preferred embodiment, it can be provided that the metal rails run through the masonry in areas that are spaced at least 30 mm, but at most 100 mm, from the side of the masonry or refractory bricks facing the metal element.

According to a particularly preferred embodiment, the grooves in which the metal rails run are formed on the bottom side of the refractory bricks, on the top side of the refractory bricks or both on the bottom side and on the top side of the refractory bricks of the masonry.

Preferably, it is provided that the contour of the grooves of the refractory bricks through which the metal rails run is adapted to the contour of the metal rails so that the metal rails run through the grooves with little or no play. This has the particular advantage that the refractory bricks can be securely fixed by the metal rails and, in particular insofar as there is a small amount of play, can be easily arranged to slide along the metal rails. Insofar as grooves are formed both on the bottom side and on the upper side of the refractory bricks of the masonry, these can together form a contour that is adapted to the contour of the metal rails.

Such grooves for receiving the metal rails have, among other things, the advantage that the masonry is particularly easy to manufacture. In this respect, a first layer of refractory bricks can be arranged next to each other to produce the masonry. If the refractory bricks of this first layer have a groove on their upper side, these grooves are aligned with each other. A metal rail is then placed on this first layer of refractory bricks, whereby the metal rail can be inserted into the rails of the rail guide at the same time, insofar as a rail guide is provided as a guide means. Insofar as the refractory bricks of the first layer have a groove on their upper side, the metal rail is simultaneously inserted into the grooves which are aligned with each other. Subsequently, another, second layer of refractory bricks is placed on the first layer of refractory bricks. If the refractory bricks of this second layer have a groove on their bottom side, these refractory bricks of the second layer are placed on the first layer of refractory bricks in such a way that the grooves of the second layer of refractory bricks are aligned with each other and the metal rail runs through the grooves of the first and second layer of refractory bricks. Additional layers of refractory bricks and metal rails can be placed on the second layer accordingly.

Preferably, the refractory bricks are arranged in one layer each such that the top sides and bottom sides of the refractory bricks in this layer each lie in one plane. The grooves formed in the refractory bricks in one layer each are preferably aligned with each other, i.e. along a longitudinal axis. This makes it particularly easy for a metal rail to run through these aligned grooves and thus through the masonry.

On one side, the masonry faces the furnace chamber. On this side, which forms the hot side of the refractory bricks of the masonry, the refractory bricks are in contact with a molten metal located in the furnace chamber.

On the opposite side, which is the cold side of the refractory bricks of the masonry, the masonry faces the metal element. This side of the masonry faces the side of the metal element facing the furnace chamber.

Opposite the side of the metal element facing the furnace chamber and at a distance from this side of the metal element the masonry of the cooling element is arranged. By arranging the masonry at a distance from the metal element, the refractory bricks of the masonry are movable relative to the metal element so that thermal expansion of the refractory bricks is not inhibited by the metal element. Further, this spacing between the metal element and the masonry creates the opportunity to fill the gap formed by this spacing with a sealant, which can further improve thermal conduction between the masonry and the metal element.

According to a preferred embodiment, it is provided that a sealing means is arranged in the gap formed between the masonry and the side of the metal element facing the furnace chamber. This sealing means is preferably a mass with good thermal conductivity, for example a mass comprising free carbon, in particular a mass comprising graphite. According to one embodiment, the sealing means is a batch compound as known from refractory technology. These sealant means can improve the thermal conductivity between the masonry and the metal element, so that heat can be conducted particularly well from the masonry via the sealant means to the metal element. Particularly preferably, the sealant means is a plastically deformable mass, i.e. a mass that exhibits plastically deformable properties at least when it is filled into the gap. In particular, the sealant means is a plastically deformable mass comprising graphite. Such a compound has the particular advantage that the sealant means conforms to the surface contour of the gap, so that particularly good thermal conductivity can be produced between the masonry and the metal element. Particularly preferably, it is a mass as embodied above and such a mass which permanently retains its plastic properties, in particular even when subjected to temperature during operational use of the furnace according to the invention, so that the mass also conforms to the surface contour of the gap during operation of the furnace and establishes particularly good thermal conductivity between the masonry and the metal element.

According to one embodiment, it is provided that the metal rails have sections that extend beyond the side of the masonry that faces the side of the metal element that faces the furnace chamber. In other words, the metal rails have sections that project beyond the masonry toward the metal element. In particular, to the extent that a sealant means of the type described above is arranged in the gap formed between the masonry and the metal element, these sections of the metal rails can project into the gap and thus into the sealant means. To this extent, these sections of the metal rails can improve heat conduction from the masonry into the sealing means and thus also to the metal element. Preferably, the sections projecting beyond the masonry extend beyond the masonry over a length of at least 5 mm, more preferably of at least 10 mm, as this allows particularly good heat dissipation from the masonry into the sealing means. Furthermore, it may be provided that these sections project beyond the masonry over a length of at most 50 mm. According to a preferred embodiment, it is provided that these sections of the metal rails extend along the predominant length of the masonry (i.e. the horizontal extension of the masonry along the metal element). According to one embodiment, it is provided that these sections of the metal rails extend along the entire length of the masonry. By these sections of the metal rails extending along the predominant or complete length of the masonry, heat can be well dissipated from the masonry along the predominant or complete length of the masonry and, in particular, dissipated into the sealant means, for example.

According to one embodiment, it is provided that the metal rails have a first section which is substantially rod-shaped and preferably with a round or oval cross-section. Preferably, this first section extends through the masonry, thus, for example, being inserted in the grooves of the refractory bricks of the masonry, as explained above. Preferably, this first section has a maximum diameter of the round or oval cross-section in the range of 15 to 50 mm, since at such a diameter a good retention of the refractory bricks in the masonry can be achieved without affecting the strength of the refractory bricks. According to one embodiment, it is provided that this first section of the metal rails is followed by a second section. This second section of the metal rails may be the section of the metal rails described above, which extends beyond the side of the masonry facing the side of the metal element. This second section may preferably have a substantially plate-like shape. Such a plate-like shape of this second section has in particular the advantage that it can abut with a large surface against the refractory bricks of the masonry and heat can therefore be well transferred from the refractory bricks to this second section of the metal rails and passed on to the sealing means or the metal element.

As guiding means, via which the metal rails are vertically guidable fastened to the metal element, basically any guiding means can be used which are used in mechanical engineering to fasten a first element guidable, in particular linearly guidable, to a second element.

According to a particularly preferred embodiment, the guide means are designed as a rail guide. By means of such a rail guide, the metal rails can be fastened to the metal elements in a particularly simple and secure vertically guidable manner. In particular, a rail guide also has the advantage that it can be designed to be simple yet robust, so that the metal rails can be securely fastened to the metal elements in a vertically guidable manner even at high temperatures. According to one embodiment, it is provided that guide means designed as rail guides comprise guide rails on which the metal rails are arranged in a vertically guidable manner. Particularly preferably, these guide rails are arranged on the side of the metal element facing the furnace chamber. For fastening and vertical guiding of the metal rails on these guide rails, the metal rails can have sections which interact with the guide rails in such a way that these sections of the metal rails form a rail guide with the guide rails, by means of which the metal rails are fastened to the metal element in a vertically guidable manner. For example, the guide rails can be designed as an undercut groove, the metal rails having a section which is inserted in this groove in such a way that the metal rails are fastened to the guide rails in a vertically guidable manner via this section. In the sense of a kinematic reversal of this embodiment, the guide rails can, for example, also lie in an undercut recess of the metal rails. The guide rails are preferably made of steel.

To arrange the guide rails on the metal element, the guide rails can, for example, be welded, riveted or—particularly preferably—screwed to the metal element.

The metal element is, in particular as known from the prior art, preferably plate-shaped or panel-shaped. Preferably, the metal element consists of a metal with good thermal conductivity, preferably copper. Particularly preferably, lines are formed in the metal element for passing a cooling fluid through the metal element, in particular a cooling fluid in the form of water.

The side of the metal element facing the furnace chamber and thus also the masonry is preferably formed flat.

The cooling element is, in particular as known from the prior art, a component of the furnace wall of the metallurgical furnace according to the invention. Preferably, the furnace wall comprises a plurality of such cooling elements. In addition to the cooling elements, the furnace wall may in particular also comprise further sections which are not designed as cooling elements.

The furnace chamber enclosed by the furnace wall is preferably designed to receive a molten metal.

In principle, the metallurgical furnace according to the invention can be any metallurgical furnace, in particular a furnace for receiving a molten metal, for example a blast furnace or an electric furnace. Particularly preferably, the metallurgical furnace according to the invention is a furnace designed for the production of copper by the flash smelting method.

Further features of the invention result from the claims, the figures as well as the associated, following figure description.

All features of the furnace according to the invention may be combined with each other, individually or in combination, as desired.

Examples of embodiments of a furnace wall of a metallurgical furnace according to the invention are shown in the attached figures and explained in more detail in the associated, following figure description.

It is illustrated in

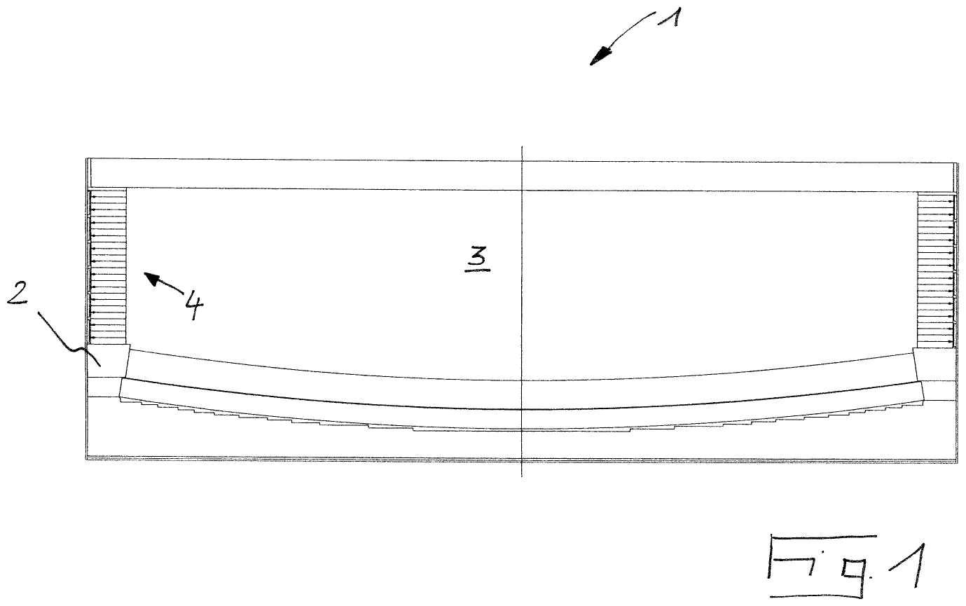

FIG. 1 an embodiment of a furnace according to the invention in a lateral sectional view;

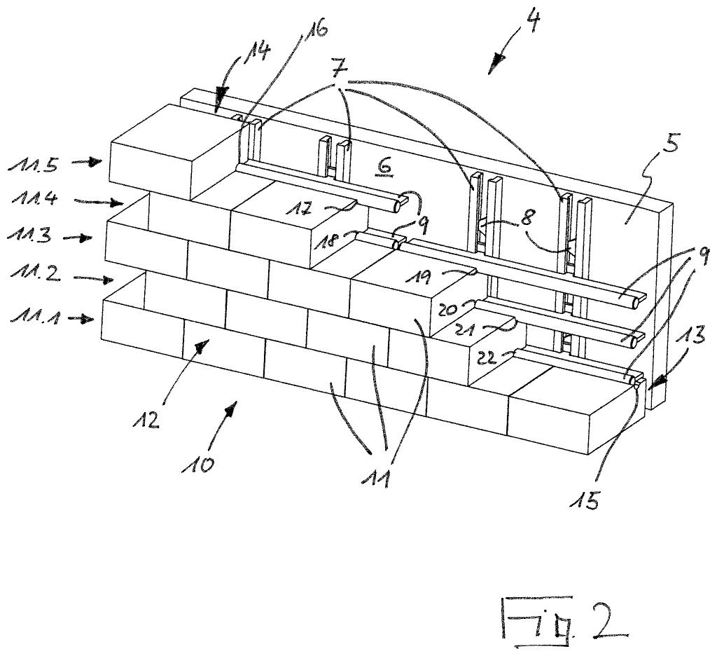

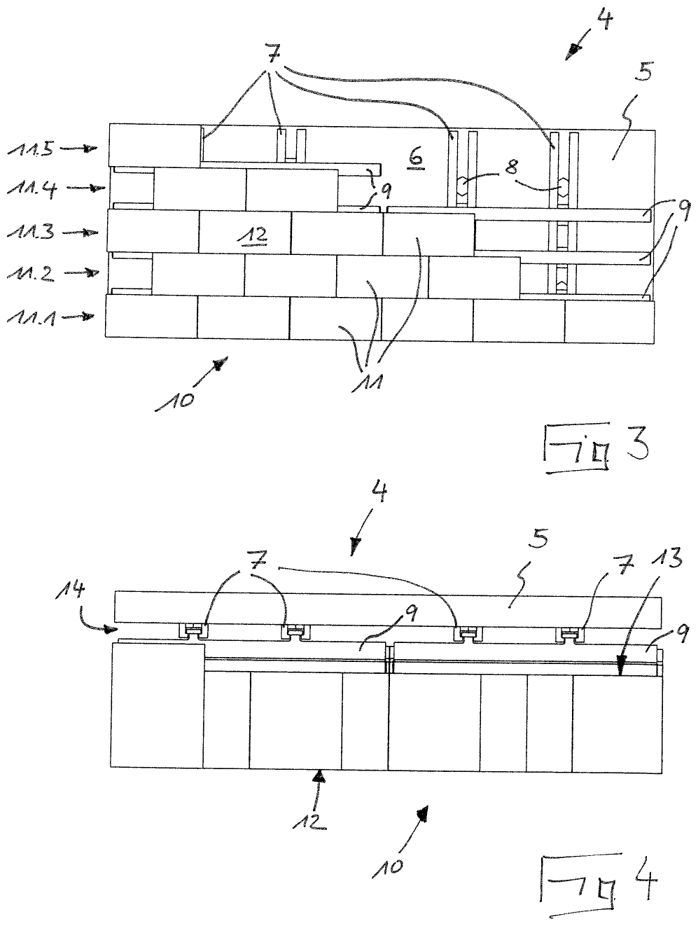

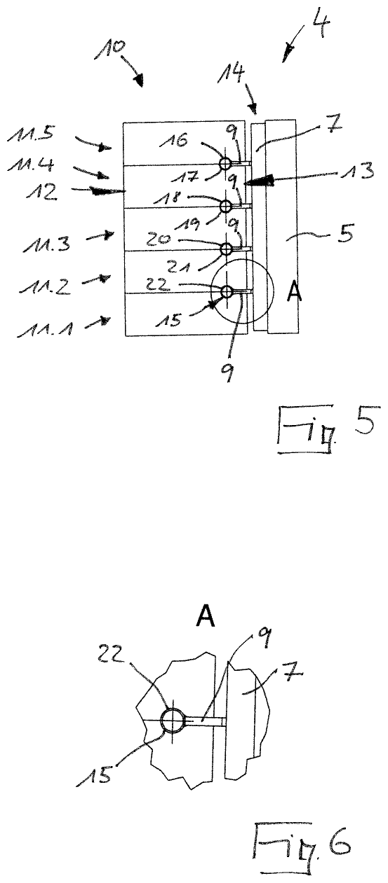

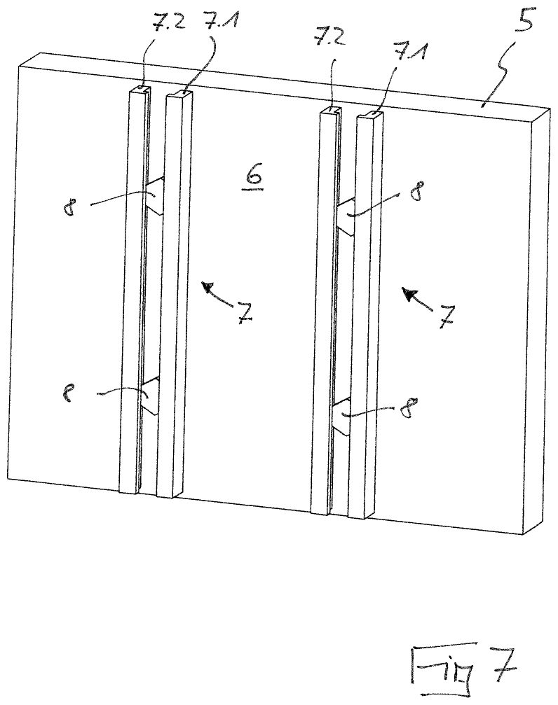

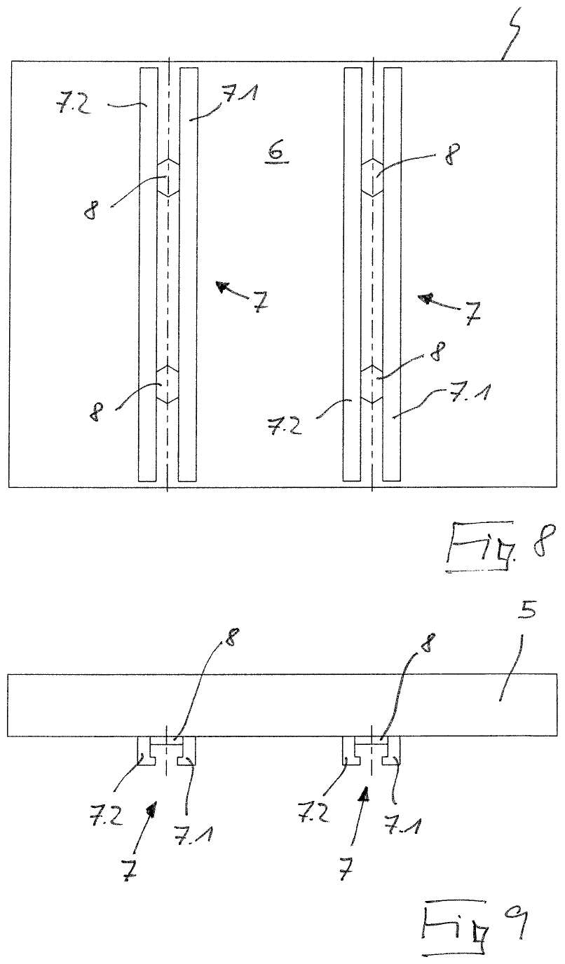

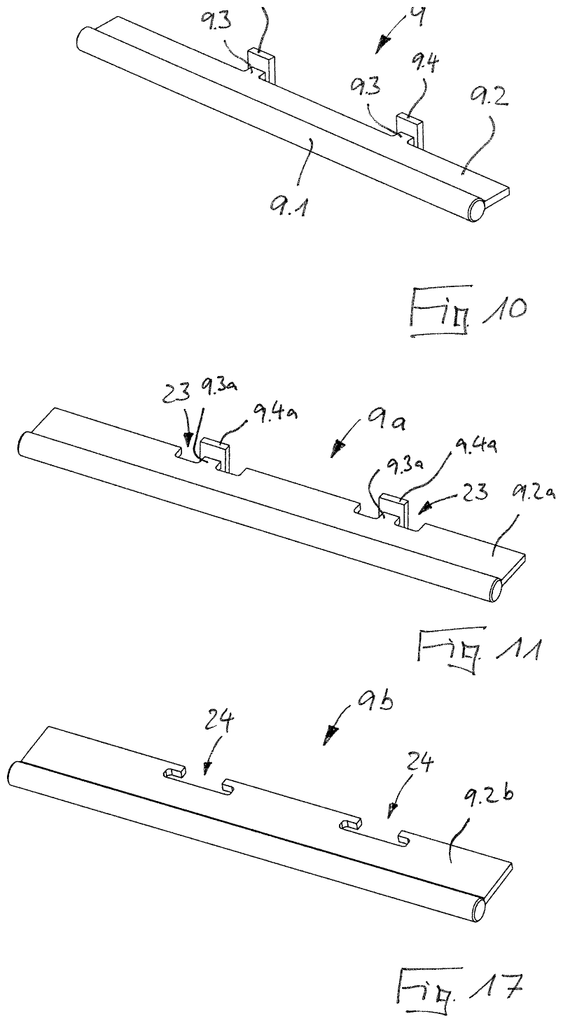

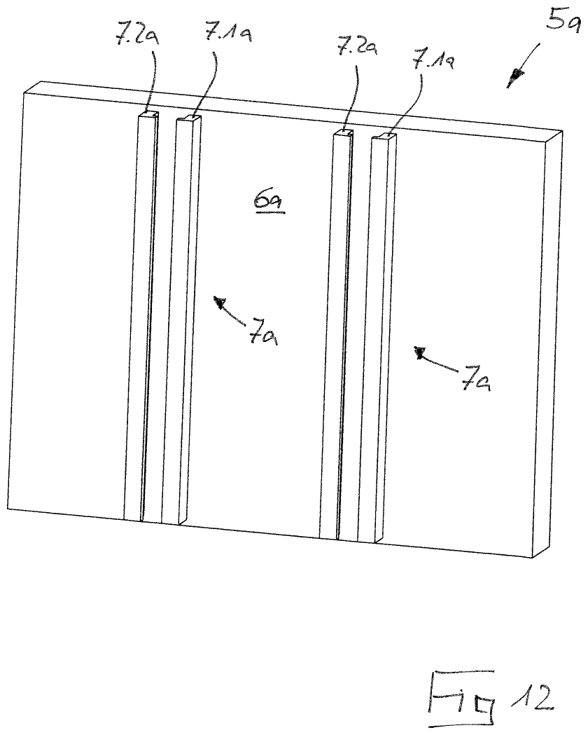

FIG. 2 a perspective view from above of a cooling element of the furnace wall of the furnace according to FIG. 1;

FIG. 3 a cooling element according to FIG. 2 in a frontal view of the masonry of the cooling element as seen from the furnace chamber;

FIG. 4 the cooling element according to FIG. 2 in a top view;

FIG. 5 a side view of the cooling element according to FIG. 2;

FIG. 6 a section of the illustration according to FIG. 5;

FIG. 7 the metal element of the cooling element according to FIG. 2 in a perspective view from oblique above;

FIG. 8 the metal element of the cooling element according to FIG. 2 in a frontal view from the masonry;

FIG. 9 the metal element of the cooling element according to FIG. 2 in a top view;

FIG. 10 a metal rail of the cooling element according to FIG. 2 in a perspective view from oblique above;

FIG. 11 an alternative embodiment of a metal rail in a perspective view from oblique above;

FIG. 12 an alternative embodiment of a metal element in a perspective view from oblique above;

FIG. 13 the metal element according to FIG. 12 in a frontal view;

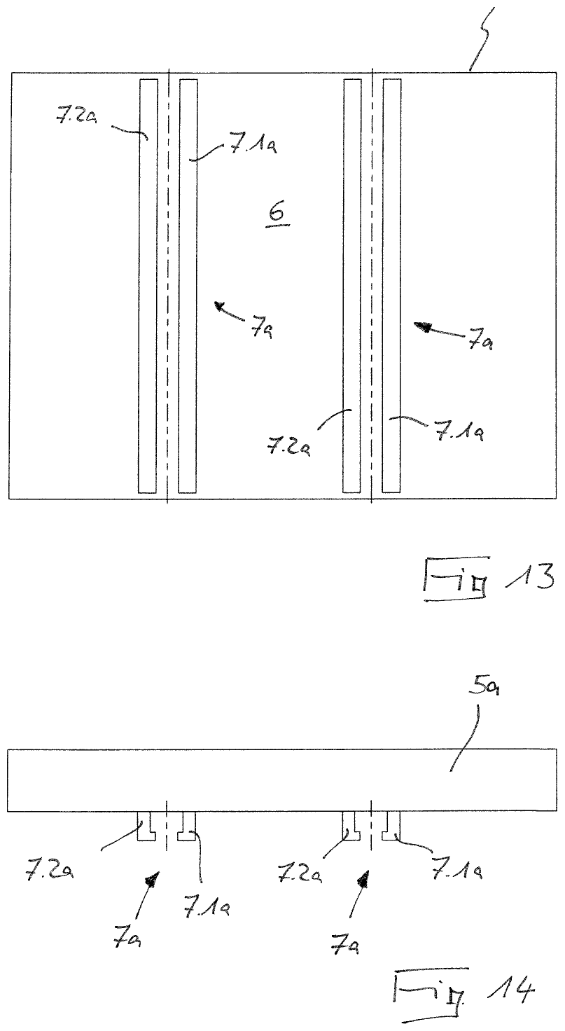

FIG. 14 the metal element according to FIG. 12 in a top view;

FIG. 15 another alternative embodiment of a metal element in a frontal view;

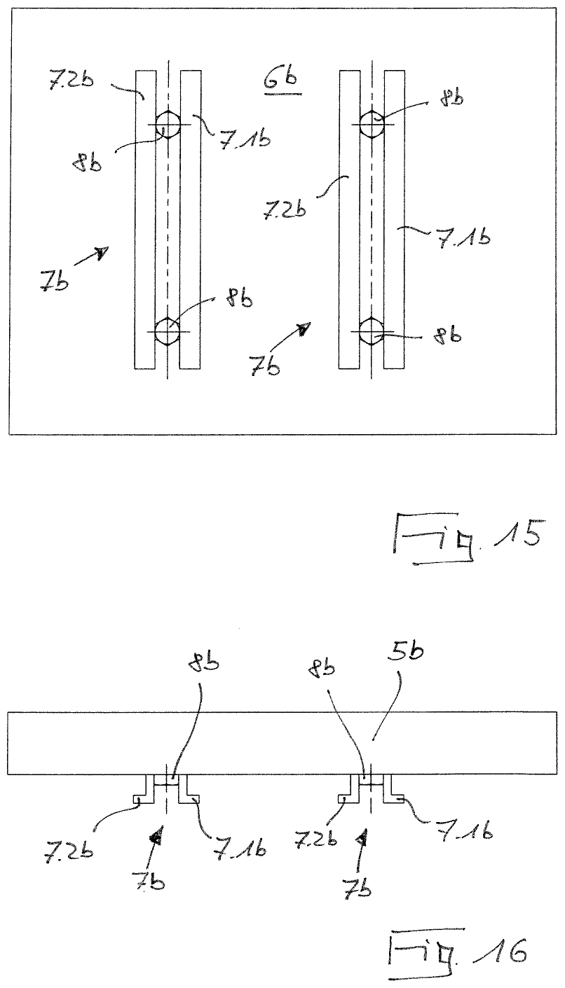

FIG. 16 the metal element according to FIG. 15 in a top view; and

FIG. 17 another alternative embodiment of a metal rail in a perspective view from oblique above.

In the Figures, identical or similarly acting elements are partially marked with the same reference signs.

The metallurgical furnace marked in its entirety with the reference sign 1 in FIG. 1 is an industrial furnace designed for the production of copper by the flash smelting process. The furnace 1 comprises a furnace wall 2 which encloses a furnace chamber 3. The furnace chamber 3 is designed to receive a molten metal, in the exemplary embodiment molten copper.

The furnace wall 2 comprises a cooling element 4 shown in more detail in FIGS. 2 to 6.

The cooling element 4 comprises a metal element 5 in the form of a tabular copper plate. Conduits (not shown) are formed inside the metal element 5 for passing a cooling fluid in the form of water through the metal element 5. The metal element 5 has a flat side 6 facing the furnace chamber 3. A plurality of guide rails 7, in the exemplary embodiment a total of four, arranged at a distance from one another, are fastened next to one another on this side 6 of the metal element 5 facing the furnace chamber 3. Each of the four guide rails 7 comprises, as can be clearly seen in FIG. 7, in each case two spaced-apart and parallel steel profiles 7.1, 7.2, which extend vertically along the side 6 of the metal element 5 facing the furnace chamber 3. The steel profiles 7.1, 7.2 of each guide rail 7 each have an L-shaped cross-section, the steel profiles 7.1, 7.2 each extending with a section away from the metal element 5 and each extending with their end distal from the metal element 5 towards one another, so that the steel profiles 7.1, 7.2 each form a guide rail 7 in the form of an undercut groove. In the exemplary embodiment of the cooling element 4 according to FIGS. 2 to 6, the steel profiles 7.1, 7.2 of each guide rail are each screwed to the metal element 5 by two screws 8.

The guide rails 7 are part of a rail guide by means of which metal rails 9 of the cooling element 4 are vertically guidable attached to the metal element 5.

The metal rails 9 are made of steel. Each of the metal rails 9 runs essentially straight, i.e. in each case along a linear longitudinal axis of the respective metal rail 9. As shown in more detail in FIG. 10, each metal rail 9 has a first, rod-shaped section 9.1 with a (perpendicular to the linear longitudinal axis) round cross-section (diameter 30 mm). Adjacent to this first section 9.1 is a second, plate-shaped section 9.2. Two spaced webs 9.3 project from this second section 9.2, to each of which a plate-shaped element 9.4 is welded at the end. The webs 9.3 and panel-shaped elements 9.4 are dimensioned in such a way that one panel-shaped element 9.4 in each case can be inserted into the groove formed in each case by a guide rail 7 and can be moved vertically in the latter. Each metal rail 9 is inserted with each of its two panel-shaped elements 9.4 in one of the grooves formed by the guide rails 7, so that the metal rails 9 are thereby fastened to the metal element 5 and at the same time can be guided vertically on the latter. To this extent, the metal rails 9 together with the guide rails 7 form guide means in the form of a rail guide, by means of which the metal rails 9 are fastened to the metal element 5 and can be guided vertically thereon at the same time.

In the exemplary embodiment according to FIGS. 2 to 6, the cooling element 4 has a total of eight metal rails 9, wherein in each case four metal rails 9, which are arranged parallel to one another and at a distance above one another, are arranged next to one another on in each case two guide rails 7.

For the sake of better illustration, only three metal rails 9 of the right four metal rails 9 are shown in FIGS. 2 and 3, and moreover some refractory bricks 11 of the masonry 10 are not shown. Furthermore, for the sake of better illustration, only the right section of the metal element 5 with the two guide rails 7 attached thereto is shown in FIGS. 7 to 9.

The metal rails 9 each run horizontally and at a constant distance from the metal element 5.

At a distance from the side 6 of the metal element 5 facing the furnace chamber 3, a masonry 10 is arranged opposite this side 6 of the metal element 5. The masonry 10 comprises substantially cuboidal refractory bricks 11 arranged in five layers 11.1, 11.2, 11.3, 11.4, 11.5 one above the other to form the masonry 10. The upper and lower sides of the refractory bricks 11 of each layer 11.1, 11.2, 11.3, 11.4, 11.5 each lie in a common plane, with adjacent layers 11.1, 11.2, 11.3, 11.4, 11.5—along the horizontal longitudinal extent of the layers 11.1, 11.2, 11.3, 11.4, 11.5—each being formed offset from one another by half a length of the refractory bricks 11.

The masonry 10 has a side 12 facing the furnace chamber 3 and an opposite side 13 facing the metal element 5. The sides 12, 13 of the masonry 10 each lie in one plane. The side 12 facing the furnace chamber 3 is in contact with the molten metal in the furnace chamber 3 during operation of the furnace 1.

The depth of the refractory bricks 11, i.e. their extension from the side 12 facing the furnace chamber 3 to the side 13 of the masonry 10 facing the metal element 5, is 350 mm.

The side 13 of the masonry 10 facing the metal element 5 runs at a distance from the side 6 of the metal element 5 facing the furnace chamber 3, so that a gap 14 is formed between the masonry 10 and the metal element 5.

The refractory bricks 11 of the lowest layer 11.1 of the masonry 10 each have a groove 15 on their upper side. The refractory bricks 11 of the uppermost layer 11.5 of the masonry 10 each have a groove 16 on their bottom side. The refractory bricks 11 of the courses 11.2, 11.3, 11.4 of the masonry 10 arranged between these courses 11.1, 11.5 each have grooves 17, 18, 19, 20, 21, 22 on their upper side as well as on their bottom side. The grooves 15, 16, 17, 18, 19, 20, 21, 22 are aligned in such a way that the grooves 15, 16, 17, 18, 19, 20, 21, 22 formed on an upper side and a bottom side, respectively, are aligned with each other.

The refractory bricks 11 are in the form of magnesia-chromite bricks, that is, sintered ceramic bricks based on the raw materials magnesia and chromite ore.

The masonry 10 is constructed without mortar and without joints. In this respect, the facing surfaces of adjacent refractory bricks 11 each lie directly against each other.

The metal rails 9 run through the mutually aligned grooves 15, 16, 17, 18, 19, 20, 21, 22 of the refractory bricks 11 of the masonry 10. In this case, the grooves 15, 16, 17, 18, 19, 20, 21, 22 on mutually abutting lower and upper surfaces of the refractory bricks 11 each form a common contour which is adapted to the contour of the metal rail 9 running through the respective groove 15, 16, 17, 18, 19, 20, 21, 22. In the embodiment example, the grooves 15, 16, 17, 18, 19, 20, 21, 22 each have a contour with a cross-sectional area (i.e. perpendicular to the longitudinal axis) in the form of a semicircle. To this extent, in the exemplary embodiment, the grooves 16 and 17, the grooves 18 and 19, the grooves 20 and 21, and the grooves 22 and 15 each form a common contour which is adapted to the respective metal rail 9. In particular, this common contour also comprises a substantially bar-shaped contour corresponding to the bar-shaped section 9.1. In this respect, the linear longitudinal axis of this common contour extends in each case at a distance of 50 mm from the side of the masonry 10 or of the refractory bricks 11 facing the metal element 5 (so that the grooves 15, 16, 17, 18, 19, 20, 21, 22 extend in each case at a distance of 35 to 65 mm from the side of the masonry 10 or of the refractory bricks 11 facing the metal element 5, due to the radius of the circular cross section of this common contour of 15 mm).

The metal rails 9 each lie with their section 9.1 in the grooves 15, 16, 17, 18, 19, 20, 21, 22 and project with their section 9.2 beyond the masonry 10 in the direction toward the metal element 5. The section 9.2 projects beyond the masonry 10 over a length of 15 mm.

In this respect, the metal rails 9 fulfill several functions at the same time. Firstly, the refractory bricks 11 of the masonry 10 are fixed to the metal element 5 by the metal rails 9, whereby the refractory bricks 11 can be moved horizontally and vertically at the same time, as explained further below. Furthermore, the metal rails 9 allow heat to be dissipated from the refractory bricks 11 to the metal element 5.

The refractory bricks 11 are displaceable along the metal rails 9, so that to this extent a horizontal displaceability of the refractory bricks in the masonry 10 is given. Furthermore, the refractory bricks 11 are vertically movable along the metal rails fixed vertically to the metal element 5 by means of the guide rails 7.

A sealant means in the form of a plastic sealant (not shown) can be introduced into the gap 14 remaining between the masonry 10 and the metal element 5, thereby improving the thermal conductivity between the masonry 10 and the metal element 5.

To construct the cooling element 4, the lower layer 11.1 of the refractory bricks 11 is first arranged at a distance from the metal element 5 and then two metal rails 9 are each inserted from above into the guide rails 7 and guided downwards in each of these until their respective rod-shaped section 9.1 lies in the grooves 15 of the lowest layer 11.1 of the refractory bricks 11. Subsequently, the second layer 11.2 of the refractory bricks 11 is arranged on this first layer 11.1 in such a way that they enclose the metal rails 9 with their grooves 22 arranged on the underside. Subsequently, the further metal rails 9 and the further layers 11.3, 11.4, 11.5 are arranged accordingly until the masonry 10 is completely erected.

Finally, the gap 14 can be filled with the sealing compound.

The masonry 10 can always form a jointless masonry 10 even in the case of a thermal expansion of the refractory bricks 11 resulting from a temperature change of the refractory bricks 11, since the refractory bricks 11 can move both horizontally along the metal rails 9 and vertically along the guide rails 7 in the case of a thermal expansion due to temperature. At the same time, the refractory bricks 11 are always securely fixed to the metal element 5 by the metal rails 9.

In the alternative embodiment of a metal rail 9a shown in FIG. 11, the panel-shaped elements 9.4a which can be inserted in the groove of the guide rail 7 are welded to webs 9.3a which are arranged in edge recesses 23 of the second section 9.2a.

FIGS. 12 to 14 show an alternative embodiment of a metal element 5a which differs from the metal element 5 according to FIGS. 2 to 9 in that the guide rails 7a are welded to the side 6a of the metal element 5a facing the furnace chamber. The steel sections of the guide rails are designated 7.1a and 7.2a.

The further alternative embodiment of a metal element 5b shown in FIGS. 15 to 16 differs from the metal element 5 according to FIGS. 2 to 9 in that the steel profiles 7.1, 7.2 of the guide rails 7b each extend away from one another with their end distal from the metal element 5b, so that the steel profiles 7.1, 7.2 each form a guide rail 7 with a T-shape. The further alternative embodiment of a metal rail 9b according to FIG. 17 can be vertically guidable fastened to this by inserting this metal rail 9b with its undercut recess 24 formed in the second section 9.2b into the guide rail 7b.

1. A metallurgical furnace (1) comprising the following features:
1.1 a furnace wall (2) enclosing a furnace chamber (3);
1.2 the furnace wall (3) comprises at least one cooling element (4), wherein the cooling element (4) comprises the following features:
1.2.1 a metal element (5) comprising a side (6) facing the furnace chamber (3);
1.2.2 a masonry (10) arranged opposite the side (6) of the metal element (5) facing the furnace chamber (3) and at a distance from this side (6) of the metal element (5);
1.2.3 the masonry (10) comprises refractory bricks (11) arranged in several layers (11.1, 11.2, 11.3, 11.4, 11.5) one above the other;
1.2.4 metal rails (9) extending through the masonry (10);
1.2.5 guide means (7, 7.1, 7.2; 9.3, 9.4) by means of which the metal rails (9) are vertically guidable fastened to the metal element (5).

2. Furnace (1) according to claim 1, wherein the masonry (10) is erected without mortar.

3. Furnace (1) according to claim 1, wherein the metal rails (9) run along the side (6) of the metal element (5) facing the furnace chamber (3).

4. Furnace (1) according to claim 1, wherein the metal rails (9) run at a constant distance from the metal element (5) along the side (6) of the metal element (5) facing the furnace chamber (3).

5. Furnace (1) according to claim 1, wherein the metal rails (9) run horizontally.

6. Furnace (1) according to claim 1, wherein the metal rails (9) run in grooves (15, 16, 17, 18, 19, 20, 21, 22) formed in the refractory bricks (11) of the masonry (10).

7. Furnace (1) according to claim 6, wherein the grooves (15, 16, 17, 18, 19, 20, 21, 22) are formed on the bottom side, the top side or both on the bottom side and the top side of the refractory bricks (11).

8. Furnace (1) according to claim 1, wherein the masonry (10) has a side (13) facing the side (6) of the metal element (5) facing the furnace chamber (3), and wherein the metal rails (9) have sections (9.2) projecting beyond said side (13) of the masonry (10).

9. Furnace (1) according to claim 8, wherein the sections (9.2) extend at least along the predominant length of the masonry (10).

10. Furnace (1) according to claim 1, wherein the guide means (7, 7.1, 7.2; 9.3, 9.4) are designed as rail guide.

11. Furnace (1) according to claim 10, wherein the rail guide (7, 7.1, 7.2; 9.3, 9.4) comprises guide rails (7) on which the metal rails (9) are vertically guidable arranged.

12. Furnace (1) according to claim 11, wherein the guide rails (7) are arranged on the side of the metal element (5) facing the furnace chamber (3).

13. Furnace (1) according to claim 1, wherein a sealing means is arranged between the metal element (5) and the masonry (10).

14. Furnace (1) according to claim 1, wherein the furnace chamber (3) is designed to receive a molten metal.

15. Furnace (1) according to claim 1, which is designed for obtaining copper by the flash smelting method.
